(19) United States
(12) Patent Application Publication
(10) Pub. No.: US 2021/0129183 A1
(43) Pub. Date: May 6, 2021

(54) PROCESS FOR EMULATING PATTERN OF A GRANULATED SURFACE FIELD

(71) Applicant: Comptek Technologies, LLC, Boulder, CO (US)

(72) Inventor: MATTHEW DORAN, DENVER, CO (US)

(21) Appl. No.: 17/023,100

(22) Filed: Sep. 16, 2020

Related U.S. Application Data
(60) Provisional application No. 62/900,839, filed on Sep. 16, 2019.

(51) Int. Cl. B05D 5/06; B05D 1/02

(52) U.S. Cl. CPC B05D 5/061; B05D 1/02

(57) ABSTRACT

The present disclosure relates to a process for applying a paint pattern to a surface. More specifically the present disclosure is directed to a process for applying paint in a spattered pattern to substantially match the pattern of a granulated surface such as, for example, a surface of concrete or granite. In an embodiment, the pattern application may be applied in an automated process.

### CROSS REFERENCE

This application claims the benefit of the filing date of U.S. Provisional Application No. 62/900,839 having a filing date of Sep. 16, 2019, the entire contents of which is incorporated by reference herein.

### FIELD

The present disclosure relates to a process for applying a paint pattern to a surface. More specifically the present disclosure is directed to a process for applying paint in a spattered pattern to substantially match the pattern of a granulated surface such as, for example, a surface of concrete or granite. In an embodiment, the pattern application may be applied in an automated process.

### BACKGROUND

In many instances, it is desirable to paint an object to match its surrounding and/or supporting environment. By way of example, it may be desirable to paint an object supported by or attached a structure to match the supporting structure to reduce the visual obtrusiveness of the object. In a specific example, it may be desirable to paint antennas (e.g., cell antennas) supported by a pole to match the coloring of the pole to reduce the overall visual obtrusiveness of the pole and supported antennas. This is a simple process when the pole is steel. The same paint may be applied to both the pole and the antennas. However, in a number of instances, a supporting pole may be formed of concrete, which may have exposed aggregate. That is, the pole may have a granulated surface with different exposed aggregates (e.g., rocks) having different colors and which each form a different percentage of the overall surface composition. Painting the objects to match such a granulated surface becomes a more difficult task. That is, skilled painters (e.g., artisans) are required to paint the object to match their supporting structures and/or environment.

What is needed is a means to identify the contents of a granulated surface such that paint may be applied to an object to substantially match the granulated surface to allow lower skilled applicators to apply such a matching granulated paint pattern and/or permit automated application of such a matching granulated paint pattern.

### SUMMARY

Provided herein are methods and systems (e.g., utilities) for creating a paint pattern on an object that substantially matches a granulated pattern of another structure. In an arrangement, the utilities control the application of wet spray paint finishing to mimic the appearance of precast concrete, which may have exposed aggregates of different colors that make up different percentages of the surface area of the precast concrete. However, it will be appreciated that the utilities may be utilized to match other granulated surfaces. The utilities variously outline matching of color tone, distribution pattern (paint spatter) and, optionally, finish (luster). Such granulated patterns may be applied to any surface including steels, plastics and fiber glasses to name a few.

The utilities include identifying an average color tone for the granulated pattern that will be matched. Such an average color tone may be performed visually using, for example, an RAL color sample pack and/or via a semi-automated process such as spectrophotometric sampling (e.g., from a predetermined distance). The average color tone may be applied to the object as a base coat.

To match the different colored gains (e.g., aggregates) of the granulated pattern, an initial calibration step is performed. In an arrangement, a photo sample of the granulated pattern may be obtained. This may define a control sample for the pattern. Different colored grains may then be identified within the control sample. For example, in concrete, different colored aggregates may be identified. Such different colors may be identified within ranges, for example, of an RGB color scale. Such identification may be performed manually or in an automated process. Typically, three or more colors are identified. In conjunction with identifying the different colors, a map may be generated for each of these colors in the control sample. This allows determining a percentage coverage of the different colors in the control sample and/or an average size of the grains of that color.

Once the colors, their percentage coverage and grain sizes are identified for each color, these colors may be applied to the base coat. Of note, the individual colors are applied in a spatter process using a paint applicator. The paint applicator typically incudes a spray nozzle of a predetermined size. Based on the size of the nozzle, the pressure applied through the nozzle and the viscosity of paint passing through the nozzle, the paint may be deposited on the object in a spatter pattern. Further, based on known variables (e.g., nozzle size, pressure, viscosity, application distance, application time/speed/distance) an average size of individual spatters may be controlled. For instance, individual spatters may have an average size that approximates the average grain size of the colors in the control sample and with a percentage coverage that approximates the coverage in the control sample. However, the spatter size may be selected based on further variables including, for example, contrast. For instance, higher contrast colors may have a reduced spatter size. Along these lines, it has been determined that in a finished product, higher contrast colors (e.g., whites, yellows) tend to appear to the human eye to be larger than lower contrast colors. In any arrangement, each color may be applied (e.g., sequentially) to the object to approximate the percentage coverage in the control sample.

In an arrangement, the lowest percentage coverage colors are applied prior to higher percentage coverage colors. In another arrangement, colors may be applied based on color tone or gray scale.

In an arrangement, the information regarding paint viscosity, pressure, nozzle size, application rate, application distance, etc., may be stored on computer readable media. In such an arrangement, an automated painting applicator may be operative to use this information to apply different colored paints in user selected spatter sizes and coverage percentages. In this regard, upon entering the spatter size and percentage coverage for each color to be applied, a granulated pattern may be applied to an object in an automated process. This is, rather than having an artisan individually paint an object to match a granulated pattern, a robotic painter may apply the granulated pattern.

### DESCRIPTION OF THE FIGURES

FIG. 1 illustrates a small cell pole having a body formed of an aggregate material.

FIG. 2A illustrates an exemplary digital image of an aggregate surface.

FIG. 2B illustrates the isolation of a first aggregate having a first color from the digital image of FIG. 2A.

FIG. 2C illustrates the isolation of a second aggregate having a second color from the digital image of FIG. 2A.

FIG. 2D illustrates the isolation of a third aggregate having a third color from the digital image of FIG. 2A.

FIG. 3A illustrates a first spatter pattern of a first paint corresponding to the first color.

FIG. 3B illustrates a second spatter pattern of a second paint corresponding to the second color.

FIG. 3C illustrates application of the second spatter pattern of FIG. 3B over the spatter pattern of FIG. 3A.

FIG. 3D illustrates a third spatter pattern of a third paint corresponding to the third color.

FIG. 3E illustrates application of the third spatter pattern of FIG. 3D over the spatter pattern of FIG. 3C.

FIG. 4 illustrates a robotic applicator.

FIG. 5 illustrates a painted version of the pole of FIG. 1.

### DETAILED DESCRIPTION

Reference will now be made to the accompanying drawings, which at least assist in illustrating the various pertinent features of the presented inventions. The following description is presented for purposes of illustration and description and is not intended to limit the inventions to the forms disclosed herein. Consequently, variations and modifications commensurate with the following teachings, and skill and knowledge of the relevant art, are within the scope of the presented inventions. The embodiments described herein are further intended to explain the best modes known of practicing the inventions and to enable others skilled in the art to utilize the inventions in such, or other embodiments and with various modifications required by the particular application(s) or use(s) of the presented inventions.

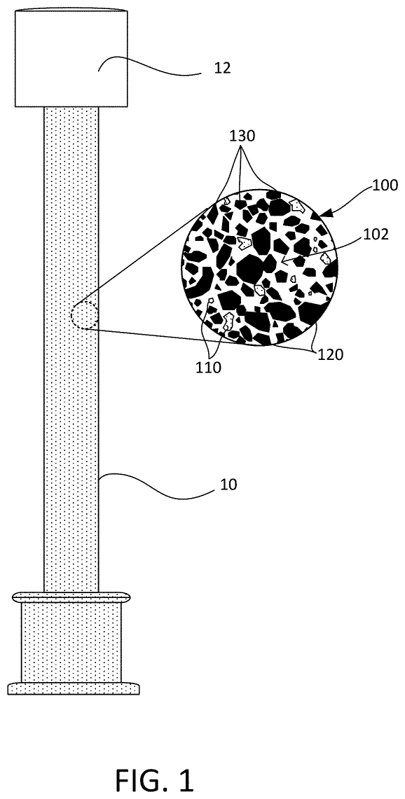

As noted above, it is sometimes desirable to reproduce a granulated pattern of an object such that that object will better match surrounding and/or supporting objects. FIG. 1 illustrates a pole 10 formed of a material (e.g., concrete) having exposed aggregates. The pole supports an antenna structure 12. To reduce the visual obtrusiveness of the antenna structure, it would be desirable to paint the antenna structure 12 to match the pole.

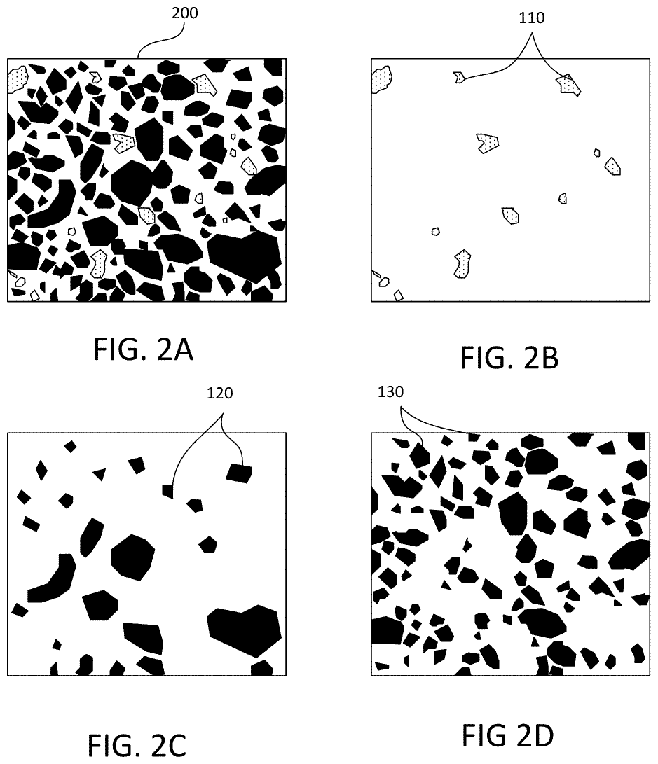

The exploded view of the pole 10 illustrates a close up view of a granulated surface 100 formed on an outside surface of the pole. As shown, the granulated surface 100 of the pole has a background binder 102 (e.g., cement) and different types of aggregates (e.g., rocks) disposed within the binder 102. During formation of the pole, its outer surface may be washed prior to the binder fully curing to expose the aggregates on the surface of the finished product. Such exposed aggregates and binder define the granulated surface. In the illustrated embodiment, the granulated surface includes three different types of aggregate having different colors, which in the present embodiment are white 110, tan 120 and black 130. Though discussed as having three colors of aggregate, it will be appreciated that additional or fewer different aggregates may be present. To replicate a granulated pattern that approximates the granulated surface 100, a digital image may be obtained of a portion of the granulated surface 100. FIG. 2A illustrates an exemplary digital image 200 of the granulated surface. The digital image 200 may from a control sample for the generation of a matching granulated pattern. Along these lines, the control sample may be mapped, which may include applying a grid scale to the digital image 200. Such a grid scale may be utilized for, inter alia, determining the size of different grains/aggregates in the control sample. Further, it will be appreciated that multiple samples may be obtained for any given granular pattern. The control sample(s) may further be used to determine color densities and/or average colors for the different grains and/or a background color. In an embodiment, control sample(s) of at least 1/2 square feet are utilized. In a further embodiment, the control sample is at least 2 square feet. In a yet further embodiment, the control sample is at least 5 square feet.

As shown in FIG. 2A, the colors considered within ranges (e.g., nm ranges in the visible light spectrum) of three colors 110, 120 and 130 (e.g., first, second and third colors). These colors may initially be identified visually or via image analysis. Such image analysis may include, for example, digital image processing utilizing full-color and/or pseudo color processing. Alternatively, such image analysis may entail utilizing a spectrophotometer.

Any image analysis may be utilized to identify (e.g., isolate) aggregates/grains of a specified color (e.g., color range). Once isolates, an average color, average grain size and percentage coverage may be identified for that specified color range. By way of example, FIG. 2B illustrates the isolation of grains/aggregate of the first color 120 from the control sample. In this regard, grains/aggregate having a color in a specified range are isolated. The total coverage area of these isolated grains may then be identified as a percentage of the sample area. Further, the total area of the identified color may be divided by the total number of identified grains to generate an average grain size. The same is done for the second color 120 as illustrated in FIG. 2C and for the third color as illustrated in FIG. 2D. At this time, the coverage percentage for each grain color and average gran size is known for each color.

In the present embodiment, an average base color was identified at predetermined distance from the control sample. The average base color is a color that may be used as a base color, when the granular pattern is generated. Alternatively, the color of the binder (e.g., cement) could be utilized. The average base color and an average grain color (or mean or other statistical sample) of the other three colors 110, 120 and 130 may then compared to a color chart such an RAL color sample pack and otherwise identified (e.g., spectrophotometric sampling) to allow selecting paints having a generally corresponding color. In the presented example, the following colors and percentages were identified as well as a corresponding color (e.g., paint). This is illustrated in Table 1:

| PAINT LAYER - ORDER OF OPERATIONS | MANUFACTURER SPECIFICATION | COLOR | COVERAGE |
|---|---|---|---|
| Primary Base Coat - Background Color Field | xxx-xxxx-x | GRAY | 100% |
| (a) Secondary Spatter - Color 110 | xxx-xxxx-x | WHITE | 12.0% |
| (b) Tertiary Spatter - Color 120 | xxx-xxxx-x | TAN | 23.0% |
| (c) Quaternary Spatter - Aggregate Color 4 | xxx-xxxx-x | BLACK | 78.5% |
| Final Clear Coat - Marine Grade Finish | xxx-xxxx-x | CLEAR | 100% |

In this example, for the concrete sample, an average color tone is assigned to the background color field as well as to each variant (i.e., three colors) of colored aggregate. The background color (e.g., base color) may then be applied to an object that will be painted in the granulated pattern.

Once the colors, coverage percentages and average grain size are determined for the control sample, a granulated pattern may be applied to an object with these parameters. To achieve proper application, modeling of the aggregate pattern is performed through low pressure wet spray application of high viscous paint. Test have been performed to identify spatter size based on paint viscosity, nozzle size, pressure, application rate and application distance. Through testing, it is currently believed the maximum controllable geometry of individual spatters is approximately 5 mm diameter. However, further testing using different parameters may produce different results.

In any arrangement, controlling coverage and spatter geometry is a function of hose pressure, nozzle adjustment, distance from workpiece, and movement of the spray gun (e.g., speed and/or time over a surface being painted). Calibration of pot pressure may be assessed for each batch of paint, periodically recalibrating (e.g., at least once for each 100 sprays). Such information may be stored to a database. Generally, a database is generated correlating different pressures, viscosities, spay gun nozzles etc. to produce different spatter patterns. Through a series of testing, the database may be established to allow reproducing various grain sizes and distributions (e.g., percentage coverages) as paint spatters.

Generally, viscosity and pressure are considered the most important controllable variables for controlling the size of the paint spatters. Secondary variables include time/speed of application and application distance. However, the spatter size may be refined based on the pattern and/or color applied. For instance, spatter size may be modified based on its contrast. That is, high contrast colors (e.g., white) may have a smaller spatter size and/or coverage percentage due to heightened contrast of the applied paint.

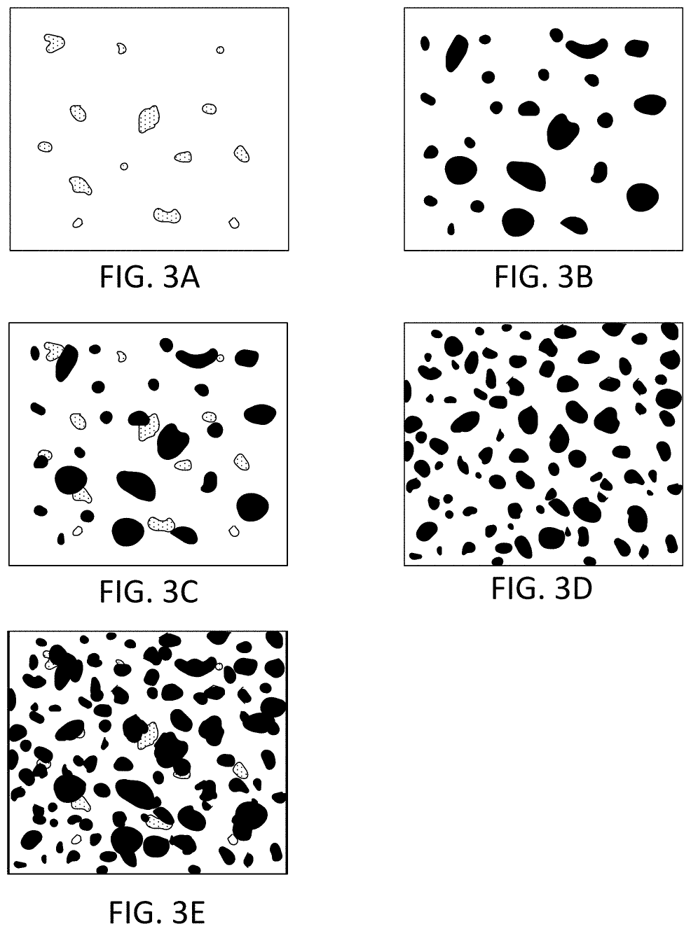

As previously noted, an object that will be painted with a granulated pattern is initially coated with the base color. That is, a continuous coat of paint may be applied to the object. Each individual paint color may then be sequentially applied to the object to form spatters similar in average size to the grains in the control sample. This is illustrated in FIGS. 3A-3E. Specifically, FIG. 3A illustrates an application of spatters of the first color 110 to produce a spatter pattern similar in grain size and percentage coverage as identified during analysis of the control sample (See, e.g., FIG. 2B). FIG. 3B illustrates an application of spatters of the second color 120 to produce a spatter pattern similar in grain size and percentage coverage as identified during analysis of the control sample (See, e.g., FIG. 2C). FIG. 3D illustrates an application of spatters of the third color 130 to produce a spatter pattern similar in grain size and percentage coverage as identified during analysis of the control sample (See, e.g., FIG. 2D).

In an embodiment, the paint colors are applied based on their percentage of coverage. That is, lower coverage percentages are applied first. As illustrated in FIGS. 3A-3E, the first color 110 (lowest percentage coverage) is applied over an object painted with the base color. See, for example FIG. 3A. After application of the first color 110, the second color is applied to the object including the base color and the first color. See. FIG. 3C. Finally, in this example, the third color (e.g., highest percentage coverage) is applied to the object having the base color, first color and second colors. See. FIG. 3E. As a result, an object may be painted in a pattern that substantially matches the grain pattern of a granular surface. See FIGS. 2A and 3E. In other embodiments, the colors may be applied in an order of paint tone (e.g., gray scale). Various application procedures are possible

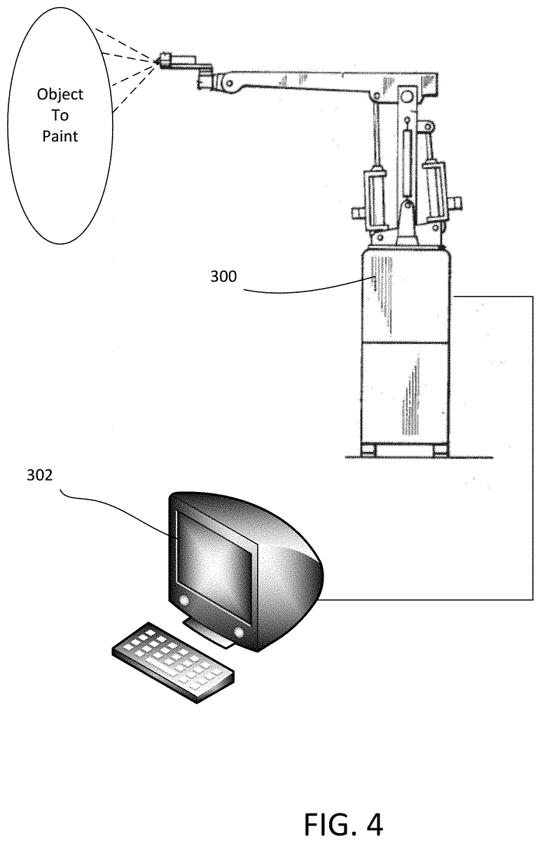

FIG. 4 illustrate one embodiment of a robotically controlled paint applicator 300 for use in painting a granular pattern on an object. As shown, the robotic applicator 300 may be connected to a computer 302 which has data storage (computer readable media), which may include various predetermined painting variables and/or inputs that allow controlling the robotic applicator to apply a desired granular paint pattern. In use, a user may specify the colors, grain size and coverage percentages to permit the robotic applicator to autonomously reproduce a desired granular pattern.

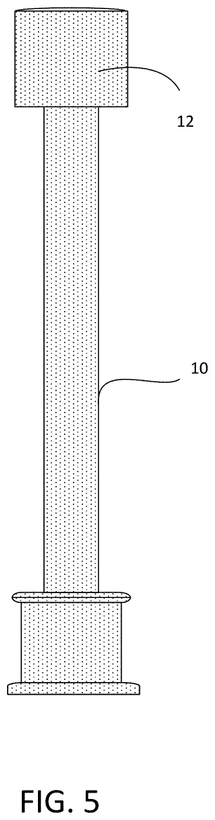

FIG. 5 illustrates the pole 10 having exposed aggregates that define a granulated pattern. Also illustrated in FIG. 5 is the antenna structure 12 supported by the pol that has been painted in accordance with the process set forth above. As shown, the resulting granular pattern painted on the shroud closely mimics the granular pattern of the concrete pole.

The foregoing description has been presented for purposes of illustration and description. Furthermore, the description is not intended to limit the inventions and/or aspects of the inventions to the forms disclosed herein. Consequently, variations and modifications commensurate with the above teachings, and skill and knowledge of the relevant art, are within the scope of the presented inventions. The embodiments described hereinabove are further intended to explain best modes known of practicing the inventions and to enable others skilled in the art to utilize the inventions in such, or other embodiments and with various modifications required by the particular application(s) or use(s) of the presented inventions. It is intended that the appended claims be construed to include alternative embodiments to the extent permitted by the prior art.

What is claimed is:

1. A method for generating and applying a granular pattern of a structure on an object, comprising:
obtaining a sample of the granular pattern of the structure;
identifying, from the sample, a base color of the structure;
identifying, from the sample, at least first, second and third grain colors of the structure and for each grain color identifying a grain size and coverage percentage within the sample;
applying a base paint corresponding to the base color to an object;
sequentially applying the first, second and third paint colors, which approximate the first, second and third grain color, to the object in a spatter paint process.

2. The method of claim 1, wherein each paint color is applied to have spatter sizes that approximate the grain size of a corresponding grain color.

3. The method of claim 2, wherein each paint color is applied to have a coverage percentage that approximate the coverage percentage of a corresponding grain color.

4. The method of claim 3, further comprising controlling application of each of the first second and third paint colors based at least in part on:
application pressure of a paint applicator; and
viscosity of an applied paint.

5. The method of claim 4, further comprising controlling application of each of the first second and third paint colors based, at least in part, on one or more of the following variables:
a nozzle size of a paint applicator applying the paint color;
a time or speed of the paint applicator over the object;
a distance between the paint applicator and the object.

6. The method of claim 5, wherein the application is applied in an automated process.

7. The method of claim 6, wherein the paint applicator is a robotic controlled applicator.
